(19) United States
(12) Patent Application Publication
(10) Pub. No.: US 2006/0266587 A1
(43) Pub. Date: Nov. 30, 2006

(54) Switch actuated electronic control module for operating various electrical loads through a microprocessor and associated circuitry provided on a circuit board

(75) Inventor: Richard Sorenson, Stuart, FL (US)

Correspondence Address: MCCORMICK, PAULDING & HUBER LLP, CITY PLACE II, 185 ASYLUM STREET, HARTFORD, CT, 06103, US

(73) Assignee: Carling Technologies, Inc., Plainville, CT (US)

(21) Appl. No.: 11/440,840

(22) Filed: May 25, 2006

Related U.S. Application Data
(60) Provisional application No. 60/685,751, filed on May 27, 2005.

(51) Int. Cl. B66B 1/28

(52) U.S. Cl. 187/247

(57) ABSTRACT

An electronic control module has rocker switches arranged in an array above a circuit board that is linked to a plurality of electrical devices through a data bus. The switches are magnetically coupled to individual transducers on the circuit board associated with these electrical devices to operate these devices remotely.

### CROSS-REFERENCE TO RELATED APPLICATION

This application claims priority from an earlier Provisional Application bearing the same title and filed May 27, 2005 under Ser. No.: 60/685,751. That earlier application is summarized herein, and is incorporated herein by reference.

### BACKGROUND

Electronic power management systems are known, and U.S. patent application Ser. No. 10/238,512 filed Aug. 29, 2002 represents one such approach to electronic power management in a system compatible with a switch actuated control module of the present invention. The disclosure of Ser. No. 10/238,512 is incorporated by reference herein.

### SUMMARY OF THE INVENTION

The present invention resides in a switch actuated control module for operating various electrical loads through a microprocessor that is programmed to prioritize these loads through a data bus. The control module houses an array of switches, each switch being associated with a specific load. The microprocessor and its associated circuitry is provided on a circuit board having an array of magnetic transducers adapted to be selectively activated mechanically for generating output control signals to selected circuits on said circuit board. The array of control switches is preferably provided so that each switch in the array of switch actuators has an internal actuator portion movable to and from a closed position wherein one of said magnetic transducers can be activated in response to said switch closed position for generating an output control signal to an associated load circuit.

### BRIEF DESCRIPTION OF THE DRAWINGS

FIG. 1 is a section through a rocker switch showing the internal actuator in the closed position. Also shown is the housing for the switch components together with the printed circuit board containing the array of magnetic transducers.

FIG. 2 is a view similar to FIG. 1 but showing the switch in the open position.

FIG. 3 is a view of an alternative switch configuration that provides a momentary closed position for the switch actuator.

FIG. 4 is a view of the switch illustrated in FIG. 3 but with the switch in the stable open position.

FIG. 5 is a view of a switch having a toggle rather than a rocker actuator but is otherwise similar to that shown in FIG. 1, the switch of FIG. 5 also being shown in the closed position.

FIG. 6 is a view of the FIG. 5 toggle switch in the open position.

FIG. 7 is a view of an alternative arrangement for the toggle switch version of the invention illustrating the internal actuator in a momentary closed position.

FIG. 8 is a view of the switch illustrated in FIG. 7, but with the toggle in the open position.

FIG. 9 is a view of the overall assembly for a switch module constructed in accordance with the present invention having switches of the style illustrated in FIGS. 1 and 2.

FIG. 10 is a bottom view of the module shown in FIG. 9.

FIG. 11 is a circuit diagram showing a preferred form for the microprocessor circuitry and related components of a module according to the invention.

### DETAILED DESCRIPTION

The control of electrical power aboard a typical marine or aerospace platform involves the monitoring and delivery of electrical energy to numerous electrical subsystems located throughout the vessel. Electrical motors, pumps, air conditioners, radar and navigation equipment together with other on board subsystems for entertainment and refrigeration and the like require that electrical power be supplied to these various electrical loads from a common power source by relatively heavy gauge electrical conductors.

The above-mentioned pending patent application Ser. No. 10/238,512 filed Aug. 29, 2002 depicts in schematic fashion a power distribution system that comprises a microprocessor module and a power distribution module all referred to as a “power distribution unit”. The present invention provides an efficient assembly for the equivalent of that microprocessor module. Manual manipulation of conventional electrical rocker or toggle switches provides the input signals to the microprocessor and its associated circuitry.

Another feature of the present invention is to provide the microprocessor and its associated circuitry in the same module or housing as these electrical input switches.

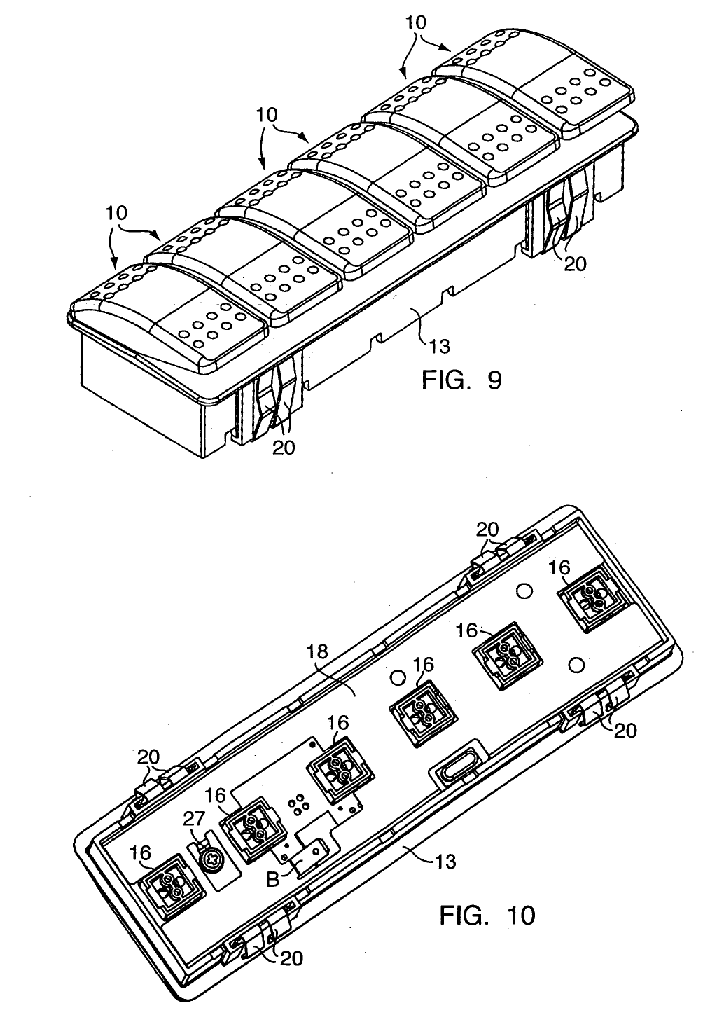

FIG. 9 shows an assembly of 6 rocker switches 10, 10 provided for individual operation in a housing 13, the housing providing pivotal support for each of the rockers, and including resilient wings 20, 20 such that the entire assembly can be conveniently mounted in a control panel.

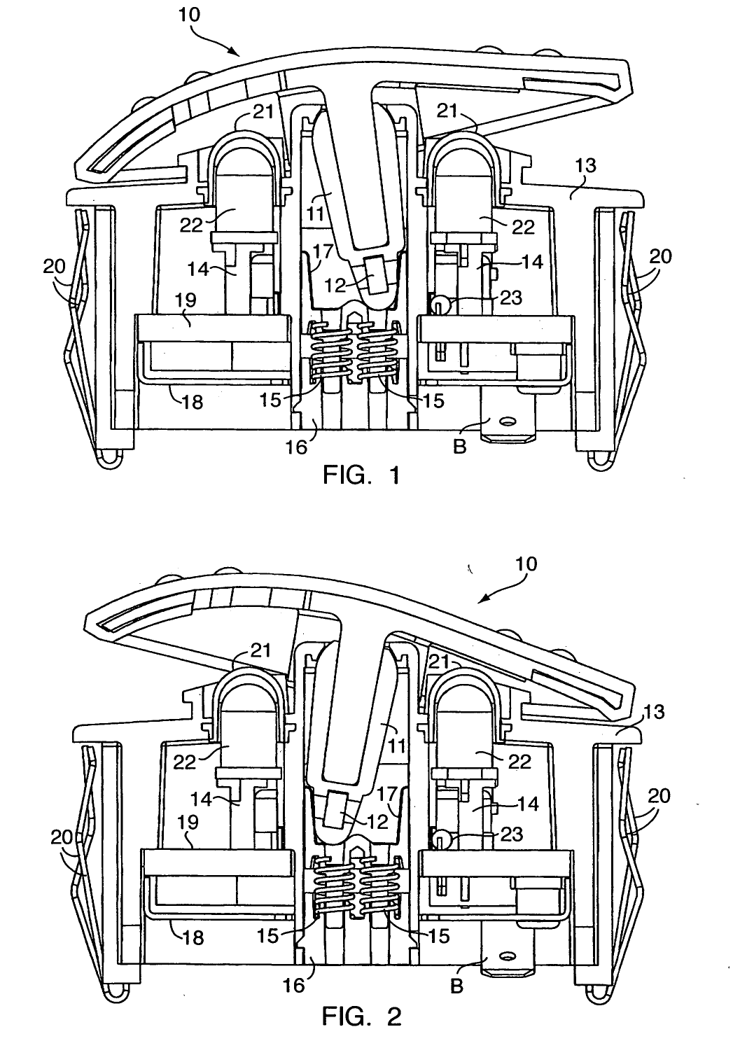

Referring now to the sectional view of one of these individual rocker switches 10 (as portrayed in FIG. 1) it will be apparent that the housing 13 functions as a switch bracket of a conventional rocker switch, and that the assembly has a bottom wall or plate 16 to define a suitable enclosure for the internal switch components to be described.

The heart of the assembly comprises a printed circuit board 19 that is held against an abutment surface defined by the housing 13 by a shielding plate 18 preferably of metal, the plate in turn being held in place by the bottom plate 16.

The printed circuit board includes an array of magnetic transducers, preferably in the form of reed switches 23, adapted to be closed by a magnet 12 provided for this purpose in an actuator portion 11 internally of the switch housing.

The actuator portion 11 moves with the rocker 10, and pivots from and to the closed position shown in FIG. 1 to the open position of FIG. 2. As it moves in this manner the lower portion of actuator 11 acts on plunger 17 to cause springs 15 to compress as the plunger moves vertically in response to the pivotal movement of the rocker/actuator. This geometry provides suitable “feel” for the rocker switch, while at the same serving to open and close the reed switch 23 provided for this purpose on the circuit board 19. Note that the springs 15 are provided between the plunger 17 and a fixed plug provided in the plate 16.

Each rocker switch 10 is fitted with a pair of LED's 22, 22, one of which is energized in response to dosing of its associated reed switch 23. The other LED is provided for the purpose of illuminating that particular switch generally so as to provide reference to that particular switch in the module, and on the control panel (not shown) in which the module is mounted.

Each LED is supported on the circuit board from which it is energized by a light pipe 14 associated with the microprocessor circuitry, and fits within an LED cover 21 provided in the switch housing 13 as shown to seal the internal switch components particularly the circuit board itself from environmental damage. Such an arrangement also affords easy egress to the circuit board, and associated LED mounting posts 14, on which the LED's are provided in the event of maintenance and repair/replacement.

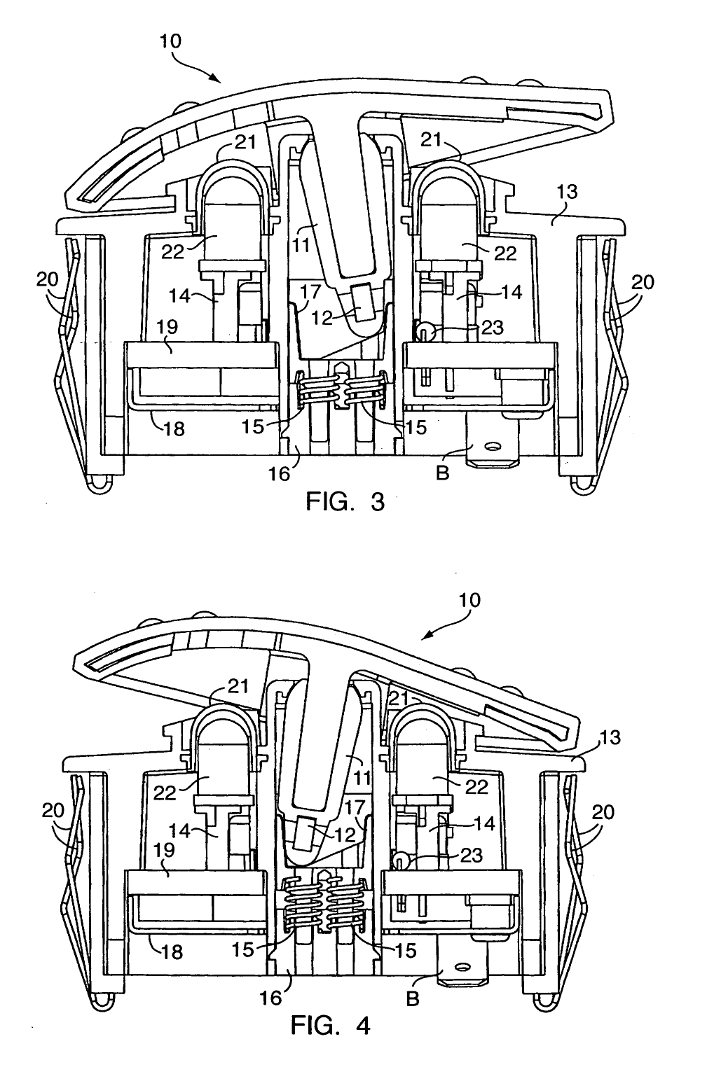

FIG. 3 shows a rocker switch 10 similar to that of FIGS. 1 and 2 but wherein the plunger 24 is provided with a ramp surface to give that rocker switch a momentary closed or “on” condition/position. Note that the ramp surface for the plunger 24 also includes a drain hole to carry away any moisture or water entering this portion of the housing through the pivot provided for the rocker action.

FIG. 4 illustrates the normal “off” or “open” position for the momentary rocker switch 10 of FIG. 3.

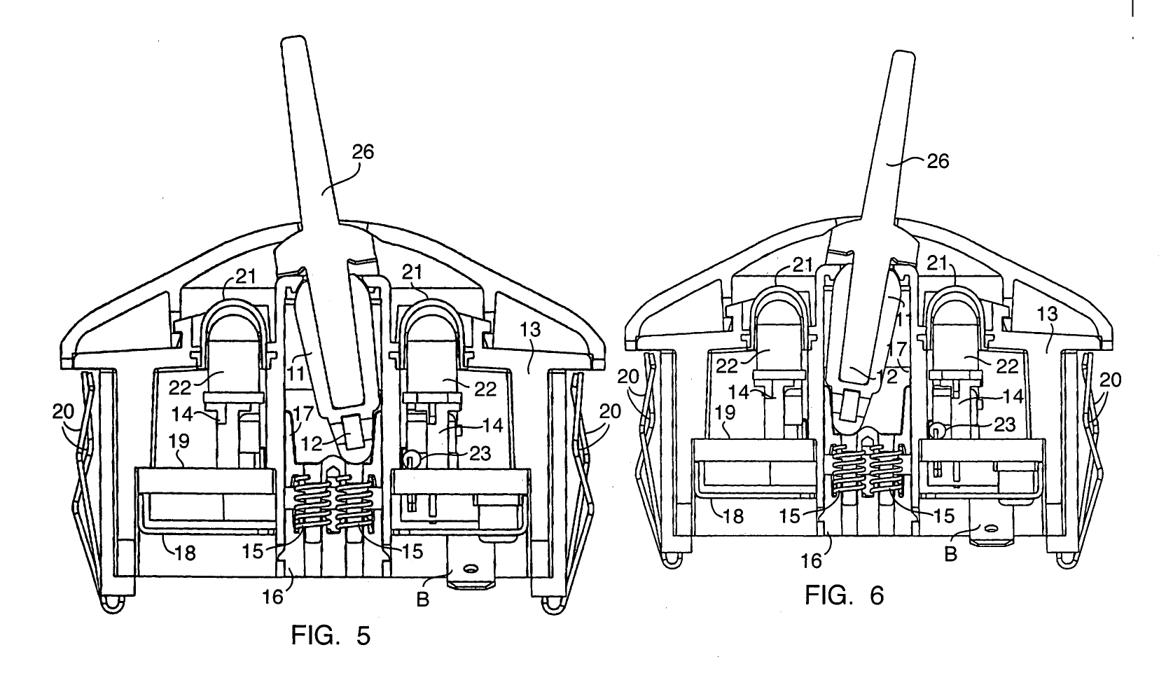

FIG. 5 is an alternative switch configuration that includes the same internal components as described previously with reference to FIGS. 1 and 2, but a slightly different actuator shape 10. Instead of a rocker shaped actuator, the switch of FIG. 5 provides a toggle actuator 26 that serves the same purpose.

FIG. 6 shows the toggle 26 in an open condition such that the magnet 12 is spaced away from the reed switch 23, opening an associated circuit defined for this purpose in the circuit board 19.

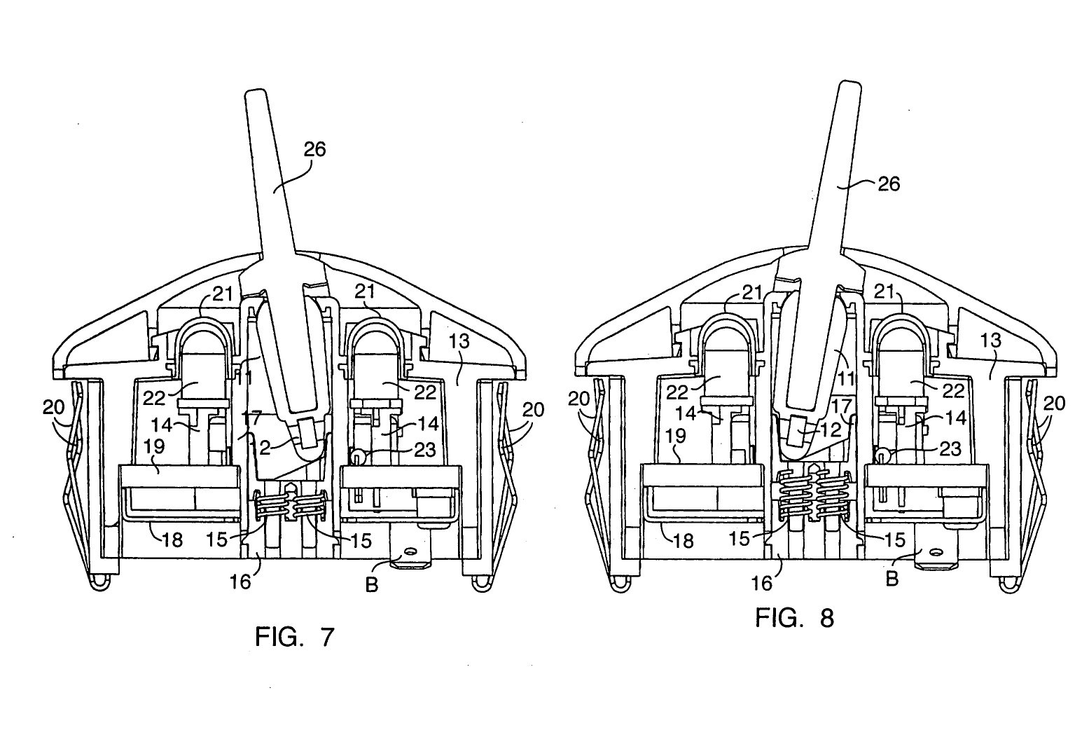

FIG. 7 shows a momentary plunger 24 associated with the toggle actuator 26 and operates in the same manner as the rocker switch described above with reference to FIGS. 3 and 4.

FIG. 8 shows the momentary toggle switch of FIG. 7 in the “open” condition such that the magnet 12 in the lower or inner actuator portion is remote from its associated reed switch 23.

FIG. 10 shows the underside of the module assembly of FIGS. 1-9, and illustrates in greater detail the geometry for the plug plate 16, as well as the shielding plate 18. Mounting screws 27 provide a clamping force between the housing components 13 and shielding plate 18. Power is provided to the internal circuit board 19 by blade terminal B.

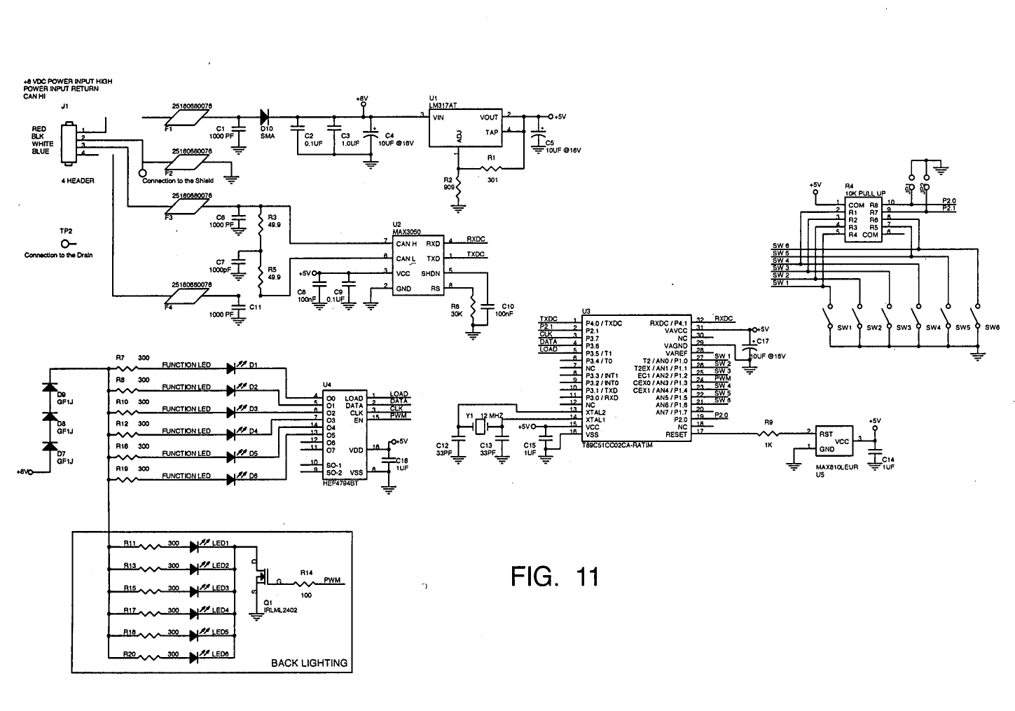

Although the disclosure in the above-mentioned patent application Ser. No. 10/238,512 filed Aug. 29, 2002 is incorporated by reference herein, FIG. 11 shows a preferred version of the microprocessor, and associated microprocessor circuitry, provided on the circuit board 19 in the assembly of FIGS. 9 and 10. FIG. 11 shows the 6 LED's required for back lighting purposes, and also shows the circuitry for selective illumination through the paired LED's so as to afford both a red and green indicator function in each of the 6 rocker switch actuators.

Also shown in FIG. 11 are inputs and outputs to the microprocessor itself, including the preset limits corresponding to in the power levels associated with each of the individual electrical subsystems or loads controlled by the control module of the present invention. Thus, power is supplied to the various loads in a platform or vessel in a marine or other environment, and a serial data bus communicates with each unit to be supplied with electrical power as suggested in prior art U.S. Pat. No. 5,854,454 issued to Upender et al., and also incorporated by reference herein.

The unique arrangement of switches assembled in accordance with the present invention not only provides for the selective activation of the individual electrical subsystems to be controlled, but also provides feedback information in the form of an annunciater panel contained within each of the electrical switches by reason of the unique LED display afforded internally of the control module itself. Rather than requiring separate control, annunciater, and switching assemblies, the present invention provides a single housing for all three functions. Additionally, the predetermined limits for the various power levels associated with each of the individual loads or subsystems can be conveniently preprogrammed in the microprocessor circuitry of FIG. 11 prior to assembly of the various components described above.

1. A preprogrammed control module for operating various electrical loads through a microprocessor that is programmed to prioritize these loads through a serial data bus, said control module comprising:
an array of pivotally mounted switches, each switch associated with a specific load,
a printed circuit board having microprocessor circuitry capable of selecting, monitoring and prioritizing electrical power to several electrical subsystems, said circuit board further including magnetic transducers arranged on said board so as to be selectively activated magnetically to generate output signals
each switch in said array of switches having a portion movable to and from a closed position wherein at least one of said magnetic transducers is activated.

2. The combination of claim 1 further including a plurality of LED's arranged on said circuit board for selective engerization in response to activation of said magnetic transducers to indicate the condition of a particular load circuit.

3. The combination of claim 2 wherein each of said LED's includes an associated light pipe to direct illumination to a predetermined portion of the switch actuator.

4. The combination according to claim 1 wherein each switch actuator is pivotally mounted in said module and includes a magnetic field inducing element that alters the state of one of said magnetic transducers when that switch actuator is in a closed or on position.

5. The combination according to claim 4 wherein each of said switches further includes a sidable plunger having a cam surface for engagement by said actuator, and biasing means to urge said plunger cam surface toward said actuator pivot axis.

6. The combination according to claim 5 wherein said magnetic transducers are reed switches mounted on said circuit board and having magnetically sensitive reeds that are affected by changes in location for said magnetic field inducing element.

7. The combination according to claim 6 further including electrical shielding means for said magnetic transducers and associated circuitry on said circuit board.

8. The combination according to claim 7 further characterized by said plunger part defining said cam surface including a drain opening immediately behind the pivot axis for said actuator to carry away any fluid entering the module through the pivot defining portion of said module housing.

9. The combination according to claim 8 wherein said module includes a polymeric housing having a bracket portion defining pivots for said actuators of said switches, each such actuator including an inner portion carrying said magnetic field including element.

10. The combination according to claim 9 wherein said module housing has mounting wings for supporting said module housing in a panel of the like.
